(19) United States
(12) Patent Application Publication
(10) Pub. No.: US 2026/0227963 A1
(43) Pub. Date: Aug. 6, 2026

(54) MAPPING METRICS TO VARIABLES FOR FORMULA CONFIGURATION

(71) Applicant: Honeywell International Inc., Charlotte, NC (US)

(72) Inventors: Agniraj Chatterji, Kolkata (IN); Rajesh Kulandaivel Sankarapandian, Cumming, GA (US); Sumanth Pachipulusu Lingesh, Bengaluru (IN); Veeranagegowda Shivalingappa, Hiriyuru (IN)

(21) Appl. No.: 19/045,959

(22) Filed: Feb. 5, 2025

(51) Int. Cl. G06F 8/35

(52) U.S. Cl. CPC G06F 8/35

(57) ABSTRACT

Devices, methods, and systems for mapping metrics to variables for formula configuration are described herein. A method can include storing, in memory, a model for mapping metrics to input variables trained on historical data, receiving, at a user interface, a formula associated with an asset, wherein the formula comprises a number of input variables, receiving, at the user interface, a command to perform an automatic mapping, mapping, by a processor in response to receiving the command, a metric to each of the number of input variables by inputting the formula and the asset into the model and the model matching at least one of: a pattern of an existing formula with a pattern of the formula or a pattern of an existing asset with a pattern of the asset, and displaying, at the user interface, the formula with each metric mapped to each of the number of input variables.

### TECHNICAL FIELD

The present disclosure relates generally to devices, methods, and systems for mapping metrics to variables for formula configuration.

### BACKGROUND

Formula configuration is a crucial step in setting up an asset matter and is used to calculate key performance indicators (KPIs) and power fault generating in runtime applications. Defining and configuring formulas for an asset (e.g., object) model is a manual effort that can be time-consuming. An asset can be equipment at an industrial site, for example.

### BRIEF DESCRIPTION OF THE DRAWINGS

FIG. 1 illustrates a block diagram of a computing device in accordance with an embodiment of the present disclosure.

FIG. 2 illustrates a block diagram of a computing device in accordance with an embodiment of the present disclosure.

FIG. 3A illustrates an example of a display on a user interface in accordance with an embodiment of the present disclosure.

FIG. 3B illustrates an example of a display on a user interface in accordance with an embodiment of the present disclosure.

FIG. 3C illustrates an example of a display on a user interface in accordance with an embodiment of the present disclosure.

FIG. 3D illustrates an example of a display on a user interface in accordance with an embodiment of the present disclosure.

FIG. 4 illustrates an example of a method for mapping metrics to variables for formula configuration in accordance with an embodiment of the present disclosure.

### DETAILED DESCRIPTION

Devices, methods, and systems for mapping metrics to variables for formula configuration are described herein. A method can include storing, in memory of a computing device, a model for mapping metrics to variables trained on historical data, receiving, at a user interface of the computing device, a formula associated with an asset, wherein the formula comprises a number of input variables, receiving, at the user interface, a command to perform an automatic mapping, mapping, by a processor of the computing device in response to receiving the command, a metric to each of the number of input variables by inputting the formula and the asset into the model and the model matching at least one of: a pattern of an existing formula with a pattern of the formula or a pattern of an existing asset with a pattern of the asset, and displaying, at the user interface, the formula with each metric mapped to each of the number of input variables.

Previously, a user may define a formula (e.g., expression) containing a wide variety of variables (e.g., inputs and outputs) then map the metrics to variables defined under asset templates manually. However, the more complex the expression and the higher the number of variables, the more effort it takes to map the metrics to the variables.

The present disclosure can simplify a user experience for configuring formulas through automated predictions and suggestions, which can improve the productivity of users by reducing time and effort, lead to faster onboarding of customers, and reduce human error thereby improving quality of configurations. This can be done using machine learning to train an artificial intelligence (AI) model to learn commonly used mappings of variables declared in expressions and automatically generate suggested mappings for each variable in the expression. The artificial intelligence model can be trained on existing formulas and learn patterns and categorize mappings based on type of expressions by analyzing the combination of operators and conditions used.

Further, the artificial intelligence model can use an asset template associated with a formula to narrow down to a set of metrics pertaining to the asset template from which it is easier to learn and predict possible mappings. Commonly used names for variables and suggesting commonly mapped metrics can also be done by the artificial intelligence model.

A level of confidence of a suggestion can be displayed in a user interface for a user to base their choice and override the suggestion for a wrong prediction, which can train the artificial intelligence model. For instance, each time a user overrides a suggested mapping with the correct one, the model is trained accordingly, which thereby improves the accuracy of the suggestions over time.

As an example, a computing device with the trained artificial intelligence model can receive, from a user, a formula associated with an asset and a command to perform an automatic mapping. The formula can include a number of input variables, and in response to receiving the command, the computing device can map a metric to each of the number of input variables by inputting the formula and the asset into the artificial intelligence model and the artificial intelligence model matching a pattern of an existing formula with a pattern of the formula and/or a pattern of an existing asset with a pattern of the asset.

The formula with each metric mapped to each of the input variables can then be displayed to the user. Further, a level of confidence for each metric mapped to each of the input variables can be calculated and displayed to the user.

In some examples, a number of metrics to map to each of the input variables can be determined by inputting the formula and asset into the artificial intelligence model, and a level of confidence for each of these determined metrics can be calculated and displayed to the user. The user can select one of these metrics, and the artificial intelligence model can be updated based on the selection.

The present disclosure can be utilized in or in combination with an enterprise performance management software designed to optimize operations, improve efficiency, and enhance decision-making across various industries. The software can provide insights for users to take action on managing assets by integrating data analytics, artificial intelligence, and Internet of Things (IoT) technologies. For example, by compiling data from IoT devices and operational systems and monitoring performance, the software can predict maintenance needs, reduce energy consumption, and extend longevity of assets.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

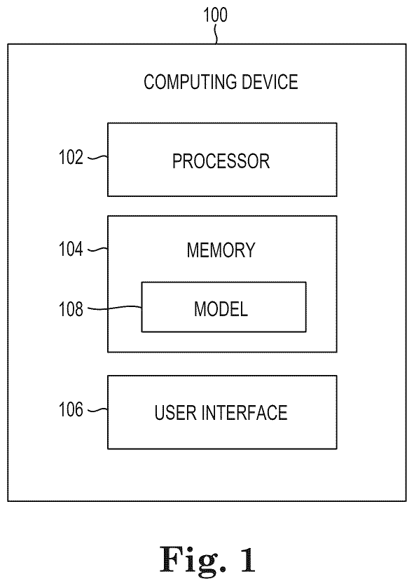

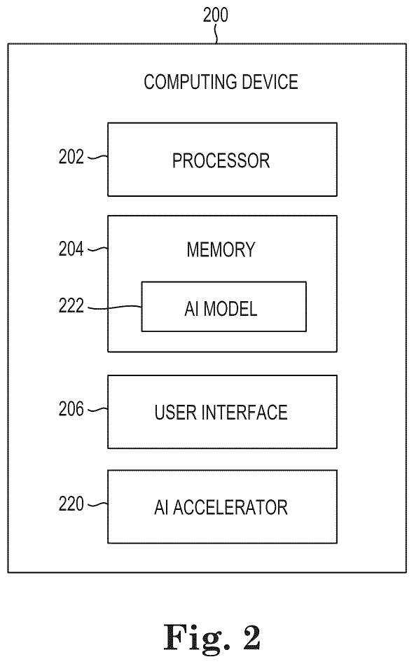

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of input variables” can refer to one or more input variables, while “a plurality of input variables” can refer to more than one input variable.

FIG. 1 illustrates a block diagram of a computing device 100 in accordance with an embodiment of the present disclosure. In some examples, the computing device 100 can be a cloud computing device, a laptop computer, a desktop computer, or a mobile device, such as, for instance, a smart phone or a tablet, among other types of computing devices.

The computing device 100 can include or download a suite of cloud-based applications to enhance operational efficiency of assets (e.g., equipment and systems) of a facility (e.g., building). These applications can incorporate data from a number of assets of the building to provide insights and analytics to optimize performance of the number of assets, streamline operations, and support data-driven decision-making. For example, the computing device 100 can collect data from the number of assets of the building to monitor, maintain, and analyze the number of assets.

The computing device 100 can collect data from the number of assets by receiving sensor data associated with the asset. The sensor data can be a metric. For example, an asset can be a tank (e.g., a pressurized tank) that includes a pressure sensor to measure a metric, in this instance, pressure in the tank.

The computing device 100 can monitor a process involving a pressurized tank in chemical manufacturing for oil, gas, and/or energy production, for instance. In a number of embodiments, a chemical manufacturing plant can use a pressurized tank to store and process volatile chemicals. To ensure safety and efficiency, a tank can be operated under a controlled pressure, temperature, and liquid and/or gas level.

The sensors on the tank including a pressure sensor, temperature sensor, liquid and/or gas level sensor, and flow rate sensor can measure and transmit their data to the computing device 100. The computing device 100 can receive this data as a number of metrics.

Each of the number of metrics can be mapped to an input variable. Each input variable can be included in a number of formulas used by the computing device 100 to predict potential issues, such as over-pressurization or temperature deviations, trigger alarms or alert operators if, for example, pressure levels are at unsafe limits, and/or identify when parts may fail. Formulas can further be used to calculate key performance indicators (KPIs) and power fault generation in runtime applications.

Having the computing device 100 receive the sensor data as metrics in real-time, mapping the metrics to input variables, and entering the input variables into formulas can improve safety, enhance efficiency, reduce downtime, and ensure regulatory compliance. For example, the computing device 100 can ensure a tank operates within safe limits, optimize tank usage, minimize unexpected failures, and log data to meet industry compliance standards.

However, in order to map the metrics to input variables, traditionally, a user would have to manually link each metric to each input variable. For example, a user would have to search through a list of metrics received at the computing device 100 and select to map it to a particular input variable.

An oil refinery could have tens to hundreds of tanks used to store liquefied petroleum gas (LPG), liquified natural gas (LNG), hydrogen, nitrogen, or other gases used in the refining process. Each of the tens to hundreds of tanks at the refinery can generate metrics that need to be mapped to input variables.

The more input variables, the more time and effort it takes for the user. Embodiments of the present application can reduce the time and effort burden on the user to improve productivity by automatically mapping some or all of the metrics to input variables, as described herein. Further, lessening reliance on manual effort may reduce chances of human error thereby improving the quality of configurations.

The computing device 100 can include a processor 102, a memory 104, and a user interface 106. Memory 104 can be any type of storage medium that can be accessed by processor 102 to perform various examples of the present disclosure. For example, memory 104 can be a non-transitory computer readable medium having non-transitory machine-readable instructions (e.g., computer program instructions) stored thereon that are executable by processor 102 to perform various examples of the present disclosure.

For instance, processor 102 can execute the executable instructions stored in memory 104 to receive, at the user interface 106, a formula associated with an asset, wherein the formula comprises a number of input variables, receive, at the user interface 106, a command to perform an automatic mapping, map in response to receiving the command, a metric to each of the number of input variables by inputting the formula and the asset into a model 108 and the model 108 matching at least one of: a pattern of an existing formula with a pattern of the formula or a pattern of an existing asset with a pattern of the asset, and display, at the user interface 106, the formula with each metric mapped to each of the number of input variables.

The memory 104 can store the model 108 and/or historical data. The model 108 can be a model for mapping metrics to input variables, and the historical data can be used to train the model 108. Historical data can include completed mappings of metrics to input variables associated with a number of formulas, assets, and/or asset templates. In some examples, the historical data can be limited to a specific zone, room, building, campus, and/or a specific industry. For example, the historical data used to train the model 108 can be limited to mappings associated with an oil refining process.

The model 108 can map metrics to input variables trained on the historical data by identifying a pattern of the formula and/or a pattern of the asset and searching for those patterns in the historical data including the pattern of the existing formula and/or the pattern of the existing asset. Patterns can include a combination of operators and conditions used. If the model 108 identifies a pattern in the historical data that matches a pattern of the formula and/or asset, the model 108 can suggest the same or similar metric previously mapped to the existing formula or existing asset.

Further, the model 108 can receive data indicating an asset template associated with the formula. The model 108 can identify historical data for which the asset template was previously used and what formula or formulas were previously associated with that asset template in order to suggest metrics for mapping.

The historical data can include commonly used names for input variables. If the received formula includes one or more of these names, the model 108 can suggest commonly mapped metrics to each of those one or more input variable names.

Further, a level of confidence can be calculated for each metric mapped to each of the number of input variables by inputting the formula and the asset into the model 108. The level of confidence can be based on the frequency of a metric being mapped to a particular input variable in the historical data. In some examples, the percentage of matching operators or conditions can dictate the level of confidence.

The level of confidence for each metric mapped to each of the number of input variables can be displayed at the user interface 106. The user interface 106 can be a graphic user interface (GUI) that can provide (e.g., display and/or present) and/or receive information to and/or from (e.g., input by) a user. User interface 106 can be, for example, a touch-screen (e.g., the GUI can include touch-screen capabilities). The user interface 106 can be localized to any language. For example, the user interface 306 can display information in any language, such as English, Spanish, German, French, Mandarin, Arabic, Japanese, Hindi, etc.

In a number of embodiments, the user interface 106 can receive a confirmation of each metric mapped to each of the number of input variables. For example, the user interface 106 can display a confirm all button and receive a selection of the confirm all button from a user. In response to receiving the selection of the confirm all button from the user, the processor 102 can map the metric of each of the number of input variables.

In some examples, the user interface 106 can display a confirm button for each respective metric mapped to an input variable. In response to receiving a selection of the confirm button for a metric, the metric associated with the confirm button can be mapped to the input variable.

The processor 102 can determine a number of metrics to map to each of the number of input variables by inputting the formula and the asset into the model 108. A level of confidence for each of the number of metrics can be calculated by the processor 102 by inputting the formula and the asset into the model. The number of metrics mapped to each of the number of input variables and the level of confidence for each of the number of metrics can be displayed at the user interface 106.

In a number of embodiments, the user interface 106 can display the number of metrics mapped to the input variable in response to the user interface 106 receiving a selection (e.g., from a user) of a drop-down menu. A metric of the number of metrics can be mapped to the input variable in response to the user interface 106 receiving a selection of the metric from the drop-down menu.

In some examples, a number of metrics can be mapped to each of the number of input variables. The processor 102 can calculate a level of confidence for each of the number of metrics mapped to the input variable by inputting the formula and the asset into the model. The user interface 106 can display the formula with each of the number of metrics mapped to the input variable and the level of confidence for each of the number of metrics mapped to the input variable.

In a number of embodiments, a selection can be received at the user interface 106 of one of the number of metrics. The processor 102 can update the model 108 based on the selection. For example, if the user selects a metric that has the highest level of confidence, the model 108 may provide a higher level of confidence for the selected metric and a lower level of confidence for the unselected metrics, the next time the same or a similar input variable is being mapped. If the user selects a metric that did not have the highest level of confidence, the model 108 may provide a higher level of confidence for the selected metric and a lower level of confidence for the unselected metrics, the next time the same or a similar input variable is being mapped.

In some examples, computing device 100 can monitor and control components and receive data including metric data from assets via a wired or wireless network (not shown in FIG. 1 for simplicity and so as not to obscure embodiments of the present disclosure). The network can be a network relationship through which the computing device 100 can communicate with other computing devices and/or sensors of assets. Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network (e.g., cloud).

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

FIG. 2 illustrates a block diagram of a computing device 200 in accordance with an embodiment of the present disclosure. Computing device 200 can correspond to computing device 100 of FIG. 1. Computing device 200 can include a processor 202, a memory 204, a user interface 206, and an artificial intelligence (AI) accelerator 220. The processor 202, the memory 204, and the user interface 206 can correspond to processor 102, memory 104, and user interface 106 of FIG. 1, respectively.

The artificial intelligence accelerator 220 can include components including hardware, software, and/or firmware that enable the artificial intelligence accelerator 220 to perform artificial intelligence operations. The hardware can include an adder/multiplier to perform logic operations associated with artificial intelligence operations.

AI operations may include machine learning or neural network operations, which may include training operations or inference operations, or both. In some examples, memory 204 may represent a number of layers within a neural network or deep neural network (e.g., a network having three or more hidden layers). In some examples, memory 204 may be or include nodes of a neural network, and a layer of the neural network may be composed of multiple memory devices or portions of several memory devices. Memory 204 may store artificial intelligence model 222, weights, inputs, outputs, and/or bias information of a neural network used by the artificial intelligence accelerator 220 to perform artificial intelligence operations.

The artificial intelligence accelerator 220 can receive commands to perform artificial intelligence operations. For example, the artificial intelligence accelerator 220 can receive a command from a host and/or the processor 202. The artificial intelligence operation can be performed in response to the command and results of the artificial intelligence operation can be reported to the host and/or processor 202 and/or stored in memory 204.

For instance, processor 202 can execute the executable instructions stored in memory 204 to receive, at the user interface 206, a formula associated with an asset, wherein the formula comprises a number of input variables, receive, at the user interface 206, a command to perform an automatic mapping using an artificial intelligence operation, map, by the artificial intelligence accelerator 220 in response to receiving the command, a metric to each of the number of input variables by inputting the formula and the asset into an artificial intelligence model 222 and the artificial intelligence model 222 matching at least one of: a pattern of an existing formula with a pattern of the formula or a pattern of an existing asset with a pattern of the asset, and display, at the user interface 206, the formula with each metric mapped to each of the number of input variables.

The memory 204 can store the artificial intelligence model 222 and/or historical data. The artificial intelligence model 222 can be a model for mapping metrics to input variables and be trained using the historical data. Historical data can include completed mappings of metrics to input variables associated with a number of formulas, assets, and/or asset templates.

In some examples, the historical data can be limited to a specific area, zone, building, campus, and/or a specific industry. For example, the historical data used to train the artificial intelligence model 222 can be limited to mappings associated with a commercial building. A commercial building can be an office complex or a hospital, for instance, with a heating, ventilation, air conditioning (HVAC) system and other energy-consuming equipment.

The artificial intelligence model 222 can map metrics to input variables trained on the historical data. For example, the artificial intelligence model 222 can identify a pattern of the formula and/or a pattern of the asset and search for those patterns in the historical data including the pattern of the existing formula and/or the pattern of the existing asset. Patterns can include a combination of operators and conditions used. If the artificial intelligence model 222 identifies a pattern in the historical data that matches a pattern of the formula and/or asset, the artificial intelligence model 222 can suggest the same or similar metric previously mapped to the existing formula or existing asset.

Further, the artificial intelligence model 222 can receive data indicating an asset template associated with the formula. The artificial intelligence model 222 can identify historical data for which the asset template was previously used and what formula or formulas were previously associated with that asset template in order to suggest metrics for mapping.

The historical data can include commonly used names for input variables. If the received formula includes one or more of these names, the artificial intelligence model 222 can suggest commonly mapped metrics to each of those one or more input variable names.

Further, a level of confidence can be calculated for each metric mapped to each of the number of input variables by inputting the formula and the asset into the artificial intelligence model 222. The level of confidence can be based on the frequency of a metric being mapped to a particular input variable in the historical data. In some examples, the percentage of matching operators or conditions can dictate the level of confidence.

The level of confidence for each metric mapped to each of the number of input variables can be displayed at the user interface 206. In a number of embodiments, the user interface 206 can receive a confirmation of each metric mapped to each of the number of input variables. For example, the user interface 206 can display a confirm all button and receive a selection of the confirm all button from a user. In response to receiving the selection of the confirm all button from the user, the processor 202 can map the metric of each of the number of input variables.

In some examples, the user interface 206 can display a confirm button for each respective metric mapped to an input variable. In response to receiving a selection of the confirm button for a metric, the metric associated with the confirm button can be mapped to the input variable.

The processor 202 can determine a number of metrics to map to each of the number of input variables by inputting the formula and the asset into the artificial intelligence model 222. A level of confidence for each of the number of metrics can be calculated by the processor 202 by inputting the formula and the asset into the artificial intelligence model 222. The number of metrics mapped to each of the number of input variables and the level of confidence for each of the number of metrics can be displayed at the user interface 206.

In a number of embodiments, the user interface 206 can display the number of metrics mapped to the input variable in response to the user interface 206 receiving (e.g., from a user) a selection of a drop-down menu. A metric of the number of metrics can be mapped to the input variable in response to the user interface 206 receiving a selection of the metric from the drop-down menu.

In some examples, a number of metrics can be mapped to each of the number of input variables. The artificial intelligence accelerator 220 can calculate a level of confidence for each of the number of metrics mapped to the input variable by inputting the formula and the asset into the artificial intelligence model 222. The user interface 206 can display the formula with each of the number of metrics mapped to the input variable and the level of confidence for each of the number of metrics mapped to the input variable.

In a number of embodiments, a selection can be received at the user interface 206 of one of the number of metrics. The artificial intelligence accelerator 220 can update the artificial intelligence model 222 based on the selection. For example, if the user selects a metric that has the highest level of confidence, the artificial intelligence model 222 may provide a higher level of confidence for the selected metric and a lower level of confidence for the unselected metrics, the next time the same or a similar input variable is being mapped. If the user selects a metric that did not have the highest level of confidence, the artificial intelligence model 222 may provide a higher level of confidence for the selected metric and a lower level of confidence for the unselected metrics, the next time the same or a similar input variable is being mapped.

In some examples, computing device 200 can monitor and control components and receive data including metric data from assets via a wired or wireless network. The network can be a network relationship through which the computing device 200 can communicate with other computing devices and/or sensors of assets.

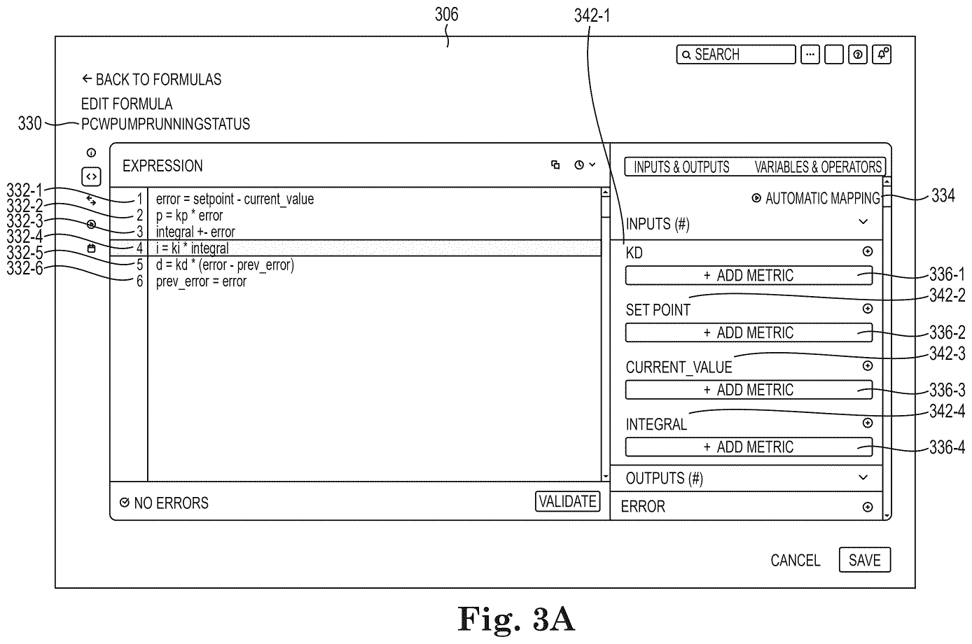

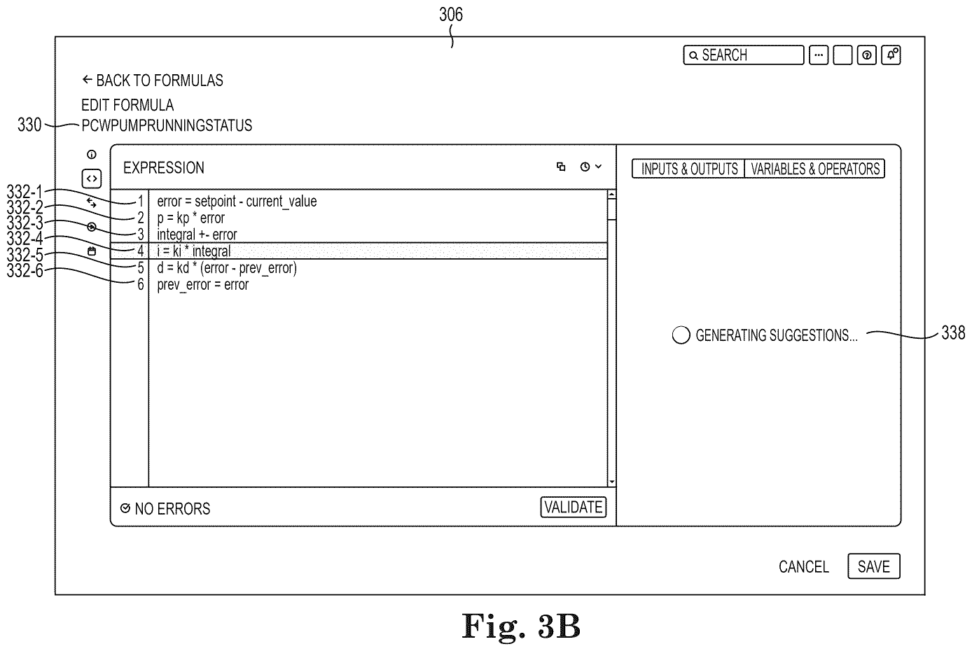

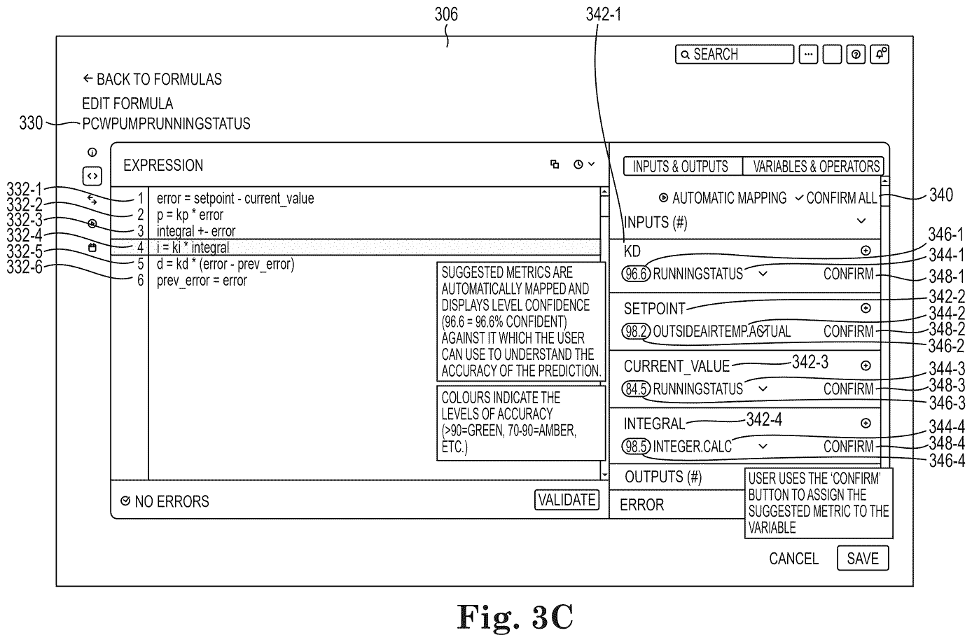

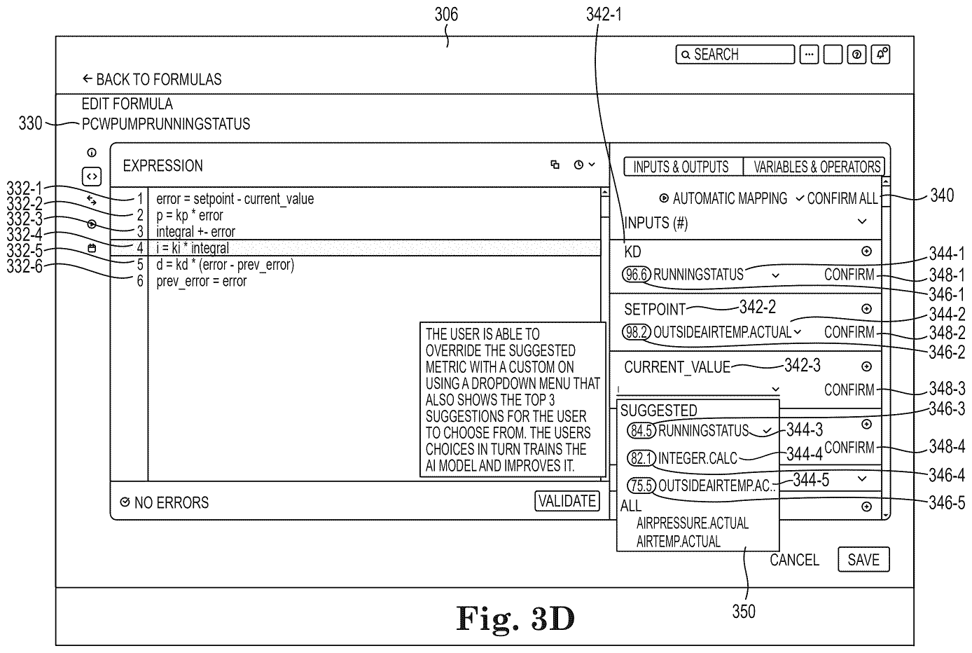

FIG. 3A illustrates an example of a display on a user interface 306 in accordance with an embodiment of the present disclosure. User interface 306 can correspond to user interface 106 and 206 of FIGS. 1 and 2, respectively.

The user interface 306 can be a graphic user interface that can provide and/or receive information to and/or from a user. For example, the user interface 306 can receive and display an asset 330 and a number of formulas 332-1, 332-2, 332-3, 332-4, 332-5, 332-6 (e.g., expressions) associated with the asset 330. In some examples, the solutions of the number of formulas 332-1, 332-2, 332-3, 332-4, 332-5, 332-6 can be used to predict maintenance needs, reduce energy consumption, and extend longevity of the asset 330.

The asset 330 can be equipment including, but not limited to, a pump, tank, column, heat exchanger, accumulator, pressure control valve at an industrial site. In the example illustrated in FIG. 3A, the asset 330 can be a pump at an oil and gas refinery. However, embodiments are not limited to this example.

The user can select the number of formulas 332-1, 332-2, 332-3, 332-4, 332-5, 332-6 or enter the number of formulas 332-1, 332-2, 332-3, 332-4, 332-5, 332-6 via the user interface 306. In the example illustrated in FIGS. 3A-3D, the number of formulas 332-1, 332-2, 332-3, 332-4, 332-5, 332-6 can include “error=setpoint−current_value” 332-1, “p=kp*error” 332-2, “integral +−error” 332-3, “i=ki*integral” 332-4, d=kd*(error−prev_error)” 332-5, and “prev_error=error” 332-6. However, embodiments are not limited to these examples.

The user interface 306 can display a number of input variables 342-1, 342-2, 342-3, 342-4 from the number of formulas 332-1, 332-2, 332-3, 332-4, 332-5, 332-6 including in the example illustrated in FIG. 3A, but not limited to, “KD” 342-1, “SET POINT” 342-2, “CURRENT_VALUE” 342-3, and “INTEGERAL” 342-4. Each of the number of input variables 342-1, 342-2, 342-3, 342-4 can have an add metric button 336-1, 336-2, 336-3, 336-4 associated therewith. For example, the user can select the add metric button 336-1 to manually select a metric to map to input variable 342-1, the user can select the add metric button 336-2 to manually select a metric to map to input variable 342-2, etc. However, the higher the number of formulas 332-1, 332-2, 332-3, 332-4, 332-5, 332-6 and the higher the number of input variables 342-1, 342-2, 342-3, 342-4, the more effort and time it takes to map the number of metrics to the number of input variables 342-1, 342-2, 342-3, 342-4.

As an additional example, user interface 306 can include an automatic mapping button 334. The user can select the automatic mapping button 334 to receive automated predictions and suggestions of mappings. Automatic mapping can improve productivity of the user by reducing time and effort, lead to faster onboarding, and reduce human error thereby improving quality of configurations.

FIG. 3B illustrates an example of a display on a user interface 306 in accordance with an embodiment of the present disclosure. User interface 306 can correspond to user interface 106 and 206 of FIGS. 1 and 2, respectively.

As illustrated in FIG. 3B, the user interface 306 can display the asset 330 and the number of formulas 332-1, 332-2, 332-3, 332-4, 332-5, 332-6. Further, the user interface 306 can convey that a computing device (e.g., computing device 100 and 200 of FIGS. 1 and 2, respectively) is generating suggestions 338. The computing device can be generating suggestions 338 of mappings in response to the user interface 306 receiving a selection of the automatic mapping button 334 in FIG. 3A. As such, automatic mapping button 334, input variables 342-1, 342-2, 342-3, 342-4, and add metric buttons 336-1, 336-2, 336-3, 336-4 are no longer displayed in FIG. 3B.

FIG. 3C illustrates an example of a display on a user interface 306 in accordance with an embodiment of the present disclosure. User interface 306 can correspond to user interface 106 and 206 of FIGS. 1 and 2, respectively.

As illustrated in FIG. 3C, the user interface 306 can display the asset 330 and the number of formulas 332-1, 332-2, 332-3, 332-4, 332-5, 332-6. Further, the user interface 306 can display the number of input variables 342-1, 342-2, 342-3, 342-4 and a number of metrics 344-1, 344-2, 344-3, 344-4, including in the example illustrated in FIG. 3C, but not limited to, “RUNNING STATUS” 344-1. “OUTSIDE AIR TEMP ACTUAL” 344-2, “RUNNING STATUS” 344-3, and “INTEGER CALC” 344-4.

The number of metrics 344-1, 344-2, 344-3, 344-4 can be displayed in response to a computing device (e.g., computing device 100 and 200 of FIGS. 1 and 2, respectively) generating suggestions, as previously described in connection with FIG. 3B. Each of the number of input variables 342-1, 342-2, 342-3, 342-4 can be mapped to a different respective metric of the number of metrics 344-1, 344-2, 344-3, 344-4. For example, input variable 342-1 can be mapped to metric 344-1, input variable 342-2 can be mapped to metric 344-2, etc.

A user can select one or more of the number of confirm buttons 348-1, 348-2, 348-3, 348-4 to assign one or more of the number of metrics 344-1, 344-2, 344-3, 344-4 to one or more of the number of input variables 342-1, 342-2, 342-3, 342-4. For example, metric 344-1 can be assigned to input variable 342-1 in response to a user selecting confirm button 348-1, metric 344-2 can be assigned to input variable 342-2 in response to a user selecting confirm button 348-2, etc.

In a number of embodiments, the user interface 306 can further include a confirm all button 340. Every input variable of the number of input variables 342-1, 342-2, 342-3, 342-4 can be mapped to a metric of the number of metrics 344-1, 344-2, 344-3, 344-4 in response to a user selecting the confirm all button 340.

A number of level of confidences 346-1, 346-2, 346-3, 346-4, for each of the number of metrics 344-1, 344-2, 344-3, 344-4 can be displayed on user interface 306. For instance, in the example illustrated in FIG. 3C, the input variable 342-1 is mapped to the metric 344-1 with a 96.6% confidence level 346-1, the input variable 342-2 is mapped to the metric 344-2 with a 98.2% confidence level 346-2, the input variable 342-3 is mapped to the metric 344-3 with a 84.5% confidence level 346-3, and the input variable 342-4 is mapped to the metric 344-4 with a 98.5% confidence level 346-4.

The confidence levels 346-1, 346-2, 346-3, 346-4 can provide an indication to the user of the accuracy of the suggestion. Further, the confidence levels 346-1, 346-2, 346-3, 346-4 can be represented by different colors indicating the different levels of accuracy. For instance, confidence levels greater than 90% may be displayed in green, confidence levels between 70% and 90% can be displayed in yellow, and confidence levels less than 70% may be displayed in red. Embodiments, however, are not limited to this example.

FIG. 3D illustrates an example of a display on a user interface 306 in accordance with an embodiment of the present disclosure. User interface 306 can correspond to user interface 106 and 206 of FIGS. 1 and 2, respectively.

As illustrated in FIG. 3D, the user interface 306 can display an asset 330, a number of formulas 332-1, 332-2, 332-3, 332-4, 332-5, 332-6, a number of input variables 342-1, 342-2, 342-3, a number of metrics 344-1, 344-2, 344-3, 344-4, 344-5, a number of confirm buttons 348-1, 348-2, 348-3, 348-4, and a confirm all button 340.

Further, the user interface 306 can display a drop-down menu 350. The drop-down menu 350 can be displayed in response to a user selecting an arrow button near one of the number of metrics 344-1, 344-2, 344-3, 344-4, 344-5. The drop-down menu 350 can include one or more of the number of metrics 344-1, 344-2, 344-3, 344-4, 344-5, suggested for one of the number of input variables 342-1, 342-2, 342-3. For instance, the drop-down menu 350 can include the suggested metrics with the three highest confidence levels.

The number of metrics 344-1, 344-2, 344-3, 344-4, 344-5 can be the most likely metrics to be associated with one of the number of input variables 342-1, 342-2, 342-3. For example, a user can select the arrow near input variable 342-3. In response to receiving the selection of the arrow near input variable 342-3, the user interface 306 can display metric 344-3, 344-4, 344-5, as illustrated in FIG. 3D.

A level of confidence of a number of level of confidences 346-1, 346-2, 346-3, 346-4, 346-5 for each of the number of metrics 344-1, 344-2, 344-3, 344-4, 344-5 can be displayed including the metrics 344-3, 344-4, 344-5 displayed in the drop-down menu 350. For example, the input variable 342-1 “KD” is mapped to the metric 344-1 “RUNNINGSTATUS”, with a 96.6% confidence level 346-1.

If a user selects a metric of the number of metrics 344-1, 344-2, 344-3, 344-4, 344-5 that does not have the highest level of confidence of the number of level of confidences 346-1, 346-2, 346-3, 346-4, 346-5 to map an input variable of the number of input variables 342-1, 342-2, 342-3 to (e.g., if the user overrides the suggested metric), a computing device (e.g., computing device 100 and 200 of FIGS. 1 and 2, respectively) will use this data to further train a model (e.g., model 108 of FIG. 1) or artificial intelligence model (e.g., artificial intelligence model 222 of FIG. 2). For example, the model can be retrained in response to a user selecting metric 344-4 with an 82.1% confidence level 346-4 over metric 344-3 with an 84.5% confidence level 346-3 at the user interface 306. The retrained model may increase the confidence level 346-4 and/or decrease the confidence level 346-3 when recommending metric 344-3 and/or metric 344-4 for input variable 342-3 and/or formula 332-1.

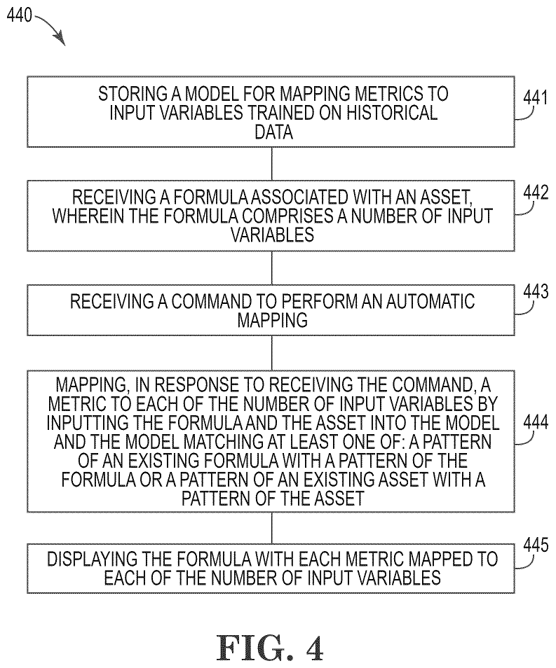

FIG. 4 illustrates an example of a method 440 for mapping metrics to input variables for formula configuration in accordance with an embodiment of the present disclosure. Method 440 can be performed by, for example, computing device 100 and/or 200 described in connection with FIGS. 1 and 2.

At block 441, method 440 includes storing a model for mapping metrics to input variables trained on historical data. The model can be stored in memory (e.g., memory 104 and 204 of FIGS. 1 and 2, respectively) of the computing device. In some examples, the model can be an artificial intelligence model. The historical data on which the model has been trained can include mappings of previous input variables to metrics.

At block 442, method 440 includes receiving a formula associated with an asset, wherein the formula comprises a number of input variables. The formula can be selected from a number of formulas displayed on a user interface (e.g., user interface 106, 206, and 306 of FIGS. 1, 2, 3A, 3B, 3C, and 3D, respectively). The number of formulas displayed on the user interface can be formulas that have been previously used by the user or can be prepopulated formulas that are commonly used for the asset.

In some examples, the formula can be manually entered by a user into the computing device. For example, the user can manually enter a formula using a keyboard or a touchscreen coupled to the computing device.

At block 443, method 440 includes receiving a command to perform an automatic mapping. As an example, the user can select an automatic mapping button (e.g., automatic mapping button 334 of FIG. 3A) on the user interface of the computing device. The automatic mapping can make it unnecessary for the user to manually map a metric to each of the number of input variables.

At block 444, method 440 includes mapping, in response to receiving the command, a metric to each of the number of input variables by inputting the formula and the asset into the model and the model matching at least one of: a pattern of an existing formula with a pattern of the formula or a pattern of an existing asset with a pattern of the asset. For example, the existing formula may have all the same input variables as the pattern. Accordingly, the computing device can suggest using the same or similar metrics as used in the existing formula for the formula.

At block 445, method 440 includes displaying the formula with each metric mapped to each of the number of input variables. In a number of embodiments, the method 440 can include receiving a confirmation of each metric mapped to each of the number of input variables. Receiving the confirmation assigns each metric mapped to each of the number of input variables.

In some examples, the method 440 can include calculating a level of confidence for each metric mapped to each of the number of input variables by inputting the formula and the asset into the model. The method 440 can further include displaying the level of confidence for each metric mapped to each of the number of input variables.

In a number of embodiments, the method 440 can include determining a number of metrics to map to each of the number of input variables by inputting the formula and the asset into the model. A level of confidence for each of the number of metrics can be calculated by inputting the formula and the asset into the model.

The number of metrics mapped to each of the number of input variables and the level of confidence for each of the number of metrics can be displayed. Further, the method 440 can include receiving a selection of one of the number of metrics at the user interface and updating the model based on the selection.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
storing, in memory of a computing device, a model for mapping metrics to input variables trained on historical data;
receiving, at a user interface of the computing device, a formula associated with an asset, wherein the formula comprises a number of input variables;
receiving, at the user interface, a command to perform an automatic mapping;
mapping, by a processor of the computing device in response to receiving the command, a metric to each of the number of input variables by inputting the formula and the asset into the model and the model matching at least one of: a pattern of an existing formula with a pattern of the formula or a pattern of an existing asset with a pattern of the asset; and
displaying, at the user interface, the formula with each metric mapped to each of the number of input variables.

2. The method of claim 1, further comprising calculating, by the processor, a level of confidence for each metric mapped to each of the number of input variables by inputting the formula and the asset into the model.

3. The method of claim 2, further comprising displaying, at the user interface, the level of confidence for each metric mapped to each of the number of input variables.

4. The method of claim 1, further comprising receiving, at the user interface, a confirmation of each metric mapped to each of the number of input variables.

5. The method of claim 1, further comprising determining, by the processor, a number of metrics to map to each of the number of input variables by inputting the formula and the asset into the model.

6. The method of claim 5, further comprising calculating, by the processor, a level of confidence for each of the number of metrics by inputting the formula and the asset into the model.

7. The method of claim 6, further comprising displaying, at the user interface, the number of metrics mapped to each of the number of input variables and the level of confidence for each of the number of metrics.

8. The method of claim 7, further comprising receiving, at the user interface, a selection of one of the number of metrics.

9. The method of claim 8, further comprising updating, by the processing resource, the model based on the selection.

10. A computing device, comprising:
a user interface;
a processor; and
a memory storing non-transitory machine-readable instructions to cause the processor to:
receive, at the user interface, a formula associated with an asset, wherein the formula comprises a number of input variables;
receive, at the user interface, a command to perform an automatic mapping;
map, in response to receiving the command, a metric to each of the number of input variables by inputting the formula and the asset into a model and the model matching at least one of: a pattern of an existing formula with a pattern of the formula or a pattern of an existing asset with a pattern of the asset;
calculate a level of confidence for each metric mapped to each of the number of input variables by inputting the formula and the asset into the model; and
display, at the user interface, the formula with each metric mapped to each of the number of input variables and the level of confidence for each metric mapped to each of the number of input variables.

11. The computing device of claim 10, wherein the model is stored in the memory.

12. The computing device of claim 10, wherein the model is an artificial intelligence (AI) model.

13. The computing device of claim 10, wherein the user interface is configured to:
display a confirm all button; and
receive a selection of the confirm all button, wherein the instructions cause the processor to map the metric to each of the number of input variables in response to receiving the selection of the confirm all button..

14. The computing device of claim 10, wherein the user interface is configured to display a number of formulas previously used by the user or previously used for the asset.

15. The computing device of claim 14, wherein the user interface is configured to receive a selection of the formula of the number of formulas previously used by the user or previously used for the asset.

16. The computing device of claim 10, wherein the user interface is configured to receive a selection of a confirm button and the instructions cause the processor to map the metric to an input variable of the number of input variables in response to receiving the selection of the confirm button.

17. A computing device, comprising:
a user interface;
a processor; and
a memory storing non-transitory machine-readable instructions to cause the processor to:
receive, at the user interface, a formula associated with an asset, wherein the formula comprises an input variable;
receive, at the user interface, a command to perform an automatic mapping;
map, in response to receiving the command, a number of metrics to the input variable by inputting the formula and the asset into a model and the model matching at least one of: a pattern of an existing formula with a pattern of the formula or a pattern of an existing asset with a pattern of the asset;
calculate a level of confidence for each of the number of metrics mapped to the input variable by inputting the formula and the asset into the model; and
display, at the user interface, the formula with each of the number of metrics mapped to the input variable and the level of confidence for each of the number of metrics mapped to the input variable.

18. The computing device of claim 17, wherein the user interface is configured to display the number of metrics mapped to the input variable in response to receiving a selection of a drop-down menu.

19. The computing device of claim 18, wherein the instructions cause the processor to map a metric of the number of metrics to the input variable in response to receiving a selection of the metric at the user interface.

20. The computing device of claim 17, wherein the user interface is configured to receive a number of formulas including the formula associated with the asset.
